(19) United States
(12) Patent Application Publication
(10) Pub. No.: US 2022/0069369 A1
(43) Pub. Date: Mar. 3, 2022

(54) POWER SUPPLY DEVICE

(71) Applicant: Toyota Jidosha Kabushiki Kaisha, Toyota-shi Aichi-ken (JP)

(72) Inventors: Yuya Ando, Ichinomiya-shi Aichi-ken (JP); Koji Ito, Nagoya-shi Aichi-ken (JP)

(73) Assignee: Toyota Jidosha Kabushiki Kaisha, Toyota-shi Aichi-ken (JP)

(21) Appl. No.: 17/400,717

(22) Filed: Aug. 12, 2021

(30) Foreign Application Priority Data
Sep. 2, 2020 (JP) 2020-147638

(51) Int. Cl. H01M 10/44; H01M 10/42; H01M 10/48; B60L 3/00

(52) U.S. Cl. CPC H01M 10/443; H01M 10/425; B60L 2240/547; B60L 3/0046; H01M 10/482

(57) ABSTRACT

A power supply device includes: a first battery; a plurality of first temperature sensors that is attached to the first battery; a second battery that is provided adjacent to the first battery; and a plurality of second temperature sensors that is attached to the second battery. A high-temperature abnormality of the second battery is diagnosed using a second abnormality diagnosis method based on temperatures from the plurality of second temperature sensors when a high-temperature abnormality has been detected in the first battery using a first abnormality diagnosis method different from the second abnormality diagnosis method based on temperatures from the plurality of first temperature sensors.

### CROSS-REFERENCE TO RELATED APPLICATION

This application claims priority to Japanese Patent Application No. 2020-147638 filed on Sep. 2, 2020, incorporated herein by reference in its entirety.

### BACKGROUND

### 1. Technical Field

The present disclosure relates to a power supply device and more particularly to a power supply device including a first battery and a second battery.

### 2. Description of Related Art

In the related art, a power supply device including a first power supply device including a first battery, a first control unit that controls charging/discharging of the first battery, and a first monitoring unit that monitors the first battery and a second power supply device including a second battery, a second control unit that controls charging/discharging of the second battery, and a second monitoring unit that monitors the second battery has been proposed as a type of power supply device (for example, see Japanese Unexamined Patent Application Publication No. 2019-92335 (JP 2019-92335 A)). In this device, when the second monitoring unit of the second power supply device has detected an abnormality in the second battery, the first monitoring unit of the first power supply device acquires a second battery state from the second monitoring unit of the second power supply device and generates availability information indicating whether the second battery is available based on a first battery state and the second battery state. The second control unit of the second power supply device acquires the availability information generated by the first power supply device and controls charging/discharging of the second battery based on the acquired availability information.

### SUMMARY

A power supply device including a first battery and a second battery often diagnoses a high-temperature abnormality of the first battery depending on whether a temperature of one of a plurality of temperature sensors attached to the first battery is equal to or greater than a threshold value, and diagnoses a high-temperature abnormality of the second battery depending on whether a temperature of one of a plurality of temperature sensors attached to the second battery is equal to or greater than a threshold value. In a power supply device in which a first battery and a second battery are provided adjacent to each other, when a high-temperature abnormality has been detected in the first battery and a high-temperature abnormality has not occurred in the second battery, it may be diagnosed that the high-temperature abnormality has occurred in the second battery when a temperature from a temperature sensor closest to the first battery out of a plurality of temperature sensors attached to the second battery is higher than a threshold value due to a high temperature of the first battery.

The present disclosure provides a power supply device that includes a first battery and a second battery which are provided adjacent to each other and that can appropriately diagnose a high-temperature abnormality in the second battery when it is diagnosed that a high-temperature abnormality has occurred in the first battery.

The power supply according to the present disclosure employs the following configurations.

According to an aspect of the present disclosure, there is provided a power supply device including: a first battery; a plurality of first temperature sensors that is attached to the first battery; a second battery that is provided adjacent to the first battery; a plurality of second temperature sensors that is attached to the second battery; and a control unit configured to manage the first battery and the second battery. The control unit is configured to diagnose a high-temperature abnormality of the second battery using a second abnormality diagnosis method based on temperatures from the plurality of second temperature sensors when a high-temperature abnormality has been detected in the first battery using a first abnormality diagnosis method different from the second abnormality diagnosis method based on temperatures from the plurality of first temperature sensors.

In the power supply device according to the aspect of the present disclosure, when a high-temperature abnormality in the first battery has been detected using the first abnormality diagnosis method based on the temperatures from the plurality of first temperature sensors attached to the first battery, a high-temperature abnormality in the second battery is diagnosed using the second abnormality diagnosis method which is different from the first abnormality diagnosis method based on the temperatures from the plurality of second temperature sensors attached to the second battery. Accordingly, it is possible to appropriately diagnose a high-temperature abnormality in the second battery when a high-temperature abnormality in the first battery has been diagnosed.

In the power supply device according to the aspect of the present disclosure, the first abnormality diagnosis method may be a method of diagnosing that the high-temperature abnormality has occurred in the first battery when the temperature from one of the plurality of first temperature sensors is equal to or greater than a first threshold value. The second abnormality diagnosis method may be a method of diagnosing that the high-temperature abnormality has occurred in the second battery when the temperature from all of the plurality of second temperature sensors is equal to or greater than a second threshold value. With this configuration, even when only the temperature from the temperature sensor provided closest to the first battery out of the plurality of second temperature sensors is equal to or greater than the second threshold value, a high-temperature abnormality in the second battery is not diagnosed. Accordingly, it is possible to appropriately diagnose a high-temperature abnormality in the second battery when a high-temperature abnormality in the first battery has been diagnosed. Here, the second threshold value may be the same value as the first threshold value or may be a value different therefrom. The first threshold value is set to a temperature which is lower than a temperature at which an abnormality such as deformation is caused in the first battery, and the second threshold value is set to a temperature which is lower than a temperature at which an abnormality such as deformation is caused in the second battery.

In the power supply device according to the aspect of the present disclosure, the control unit may be configured to limit charging of the second battery when it is not diagnosed using the second abnormality diagnosis method that the high-temperature abnormality has occurred in the second battery in a state in which the high-temperature abnormality is detected in the first battery and when a change in temperature per predetermined time from one temperature sensor other than the temperature sensor provided closest to the first battery out of the plurality of second temperature sensors is equal to or greater than a predetermined change. The limiting of charging of the second battery includes prohibition of charging of the second battery. With this configuration, it is possible to curb an increase in temperature of the second battery and to curb detection of a high-temperature abnormality in the second battery at the same time at which a high-temperature abnormality in the first battery has been detected.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically illustrating a configuration of a hybrid vehicle in which a power supply device according to an embodiment of the present disclosure is mounted; and

FIG. 2 is a flowchart illustrating an example of an abnormality diagnosing method which is performed by an HVECU.

### DETAILED DESCRIPTION OF EMBODIMENTS

Hereinafter, an embodiment of the present disclosure will be described with reference to the accompanying drawings.

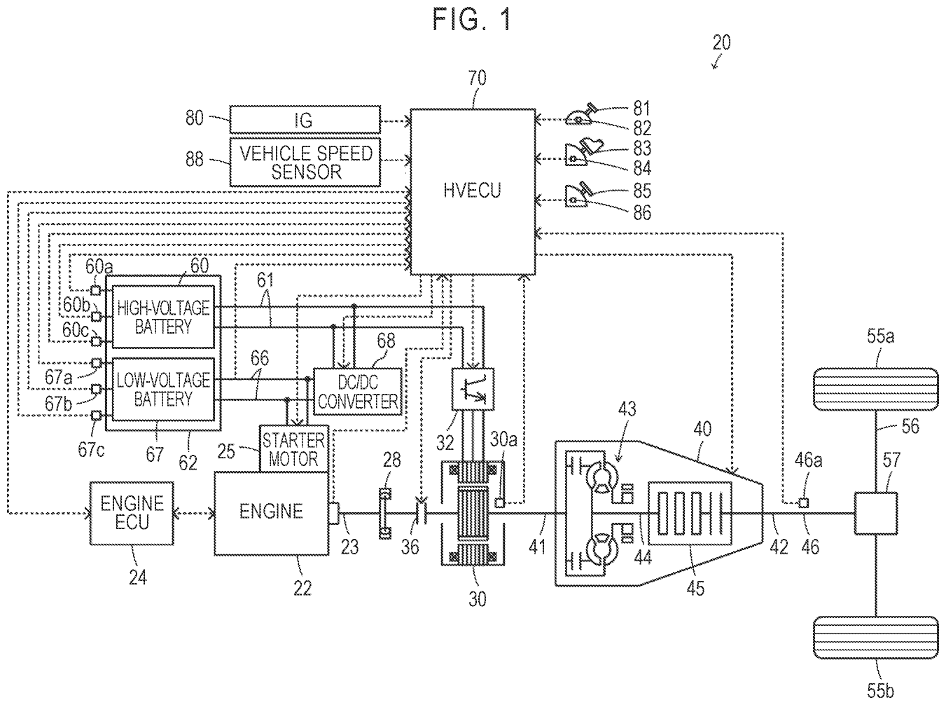

FIG. 1 is a diagram schematically illustrating a configuration of a hybrid vehicle 20 in which a power supply device according to an embodiment of the present disclosure is mounted. As illustrated in FIG. 1, the hybrid vehicle 20 according to this embodiment includes an engine 22, a motor 30, an inverter 32, a clutch 36, an automatic gear shift device 40, a high-voltage battery 60, a low-voltage battery 67, a DC/DC converter 68, and a hybrid electronic control unit (hereinafter referred to as an “HVECU”) 70.

The engine 22 is configured as a multi-cylinder (such as four-cylinder or six-cylinder) internal combustion engine that outputs power using fuel such as gasoline or diesel oil which is supplied from a fuel tank via a fuel supply system through four strokes including intake, compression, expansion (explosive combustion), and exhaust strokes. The operation of the engine 22 is controlled by an engine electronic control unit (hereinafter referred to as an “engine ECU”) 24.

Although not illustrated, the engine ECU 24 is configured as a microprocessor including a CPU as a major component and includes a ROM that stores a processing program, a RAM that temporarily stores data, input and output ports, and a communication port in addition to the CPU. Signals from various sensors required for controlling the operation of the engine 22 are input to the engine ECU 24 via the input port. Various control signals for controlling the operation of the engine 22 are output from the engine ECU 24 via the output port.

A starter motor 25 that cranks the engine 22 is connected to a crank shaft 23 which is an output shaft of the engine 22. An input side of a damper 28 which is a torsion element is also connected to the crank shaft 23 of the engine 22.

The motor 30 is configured as, for example, a synchronous power generation motor. The inverter 32 is used to drive the motor 30 and is connected to a high-voltage power line 61. The motor 30 is rotationally driven by controlling switching of a plurality of switching elements of the inverter 32 using the HVECU 70. The clutch 36 is configured as, for example, a hydraulic frictional clutch and performs engagement and disengagement between an output side of the damper 28 and a rotation shaft of the motor 30.

The automatic gear shift device 40 includes a torque converter 43, a six-stage automatic transmission 45, and a hydraulic circuit which is not illustrated. The torque converter 43 is configured as a general fluidic transmission device and transmits power of an input shaft 41 connected to the rotation shaft of the motor 30 to the intermediate rotation shaft 44 which is an input shaft of the automatic transmission 45 with an amplified torque or without amplifying a torque. The automatic transmission 45 is connected to the intermediate rotation shaft 44 and an output shaft 42 connected to the drive shaft 46 and includes a plurality of planetary gears and a plurality of frictional engagement elements (clutches and brakes) which are hydraulically driven. The drive shaft 46 is connected to rear wheels 55a and 55b via an axle 56 and a rear differential gear 57. The automatic transmission 45 forms first to sixth forward stages and a reverse stage and transmits power between the intermediate rotation shaft 44 and the output shaft 42, for example, by engagement and disengagement of the plurality of frictional engagement elements.

The high-voltage battery 60 is configured as, for example, a lithium-ion secondary battery and is connected to the high-voltage power line 61 along with the inverter 32. A plurality of temperature sensors 60a to 60c are attached to the high-voltage battery 60. The low-voltage battery 67 is configured as, for example, a lead storage battery of which the rated voltage is lower than that of the high-voltage battery 60 and is connected to a low-voltage power line 66 connected to auxiliary machinery such as the starter motor 25. A plurality of temperature sensors 67a to 67c are attached to the low-voltage battery 67. The high-voltage battery 60 and the low-voltage battery 67 are provided adjacent to each other in an arrangement platform 62. The DC/DC converter 68 is connected to the high-voltage power line 61 and the low-voltage power line 66. The DC/DC converter 68 is controlled by the HVECU 70 such that electric power of the high-voltage power line 61 is supplied to the low-voltage power line 66 with a voltage drop.

Although not illustrated, the HVECU 70 is configured as a microprocessor including a CPU as a major and includes a ROM that stores a processing program, a RAM that temporarily stores data, input and output ports, and a communication port in addition to the CPU. Signals from various sensors are input to the HVECU 70 via the input port. Examples of the signals input to the HVECU 70 include a rotational position ϕm of a rotor of the motor 30 from a rotational position sensor (for example, a resolver) 30a that detects a rotational position of the rotor of the motor 30 and a rotation speed Np of the drive shaft 46 from a rotation speed sensor 46a that is attached to the drive shaft 46. Examples thereof include a voltage Vh of the high-voltage battery 60 from a voltage sensor that is attached between terminals of the high-voltage battery 60, a current Ih of the high-voltage battery 60 from a current sensor that is attached to an output terminal of the high-voltage battery 60, and a voltage Vb of the low-voltage battery 67 from a voltage sensor that is attached between terminals of the low-voltage battery 67. Examples thereof include temperatures from the plurality of temperature sensors 60a to 60c attached to the high-voltage battery 60 and temperatures from the plurality of temperature sensors 67a to 67c attached to the low-voltage battery 67. Examples thereof include an ignition signal from an ignition switch 80, a shift position SP from a shift position sensor 82 that detects an operation position of a shift lever 81, an accelerator operation amount Acc from an accelerator pedal position sensor 84 that detects an amount of depression of an accelerator pedal 83, a brake pedal position BP from a brake pedal position sensor 86 that detects an amount of depression of a brake pedal 85, and a vehicle speed V from a vehicle speed sensor 88.

Various control signals are output from the HVECU 70 via the output port. Examples of the signals output from the HVECU 70 include a control signal for the starter motor 25, a control signal for the inverter 32, a control signal for the clutch 36, a control signal for the automatic gear shift device 40, and a control signal for the DC/DC converter 68. The HVECU 70 is connected to the engine ECU 24 via the communication port.

The high-voltage battery 60, the low-voltage battery 67, the plurality of temperature sensors 60a to 60c and 67a to 67c, and the HVECU 70 correspond to a power supply device.

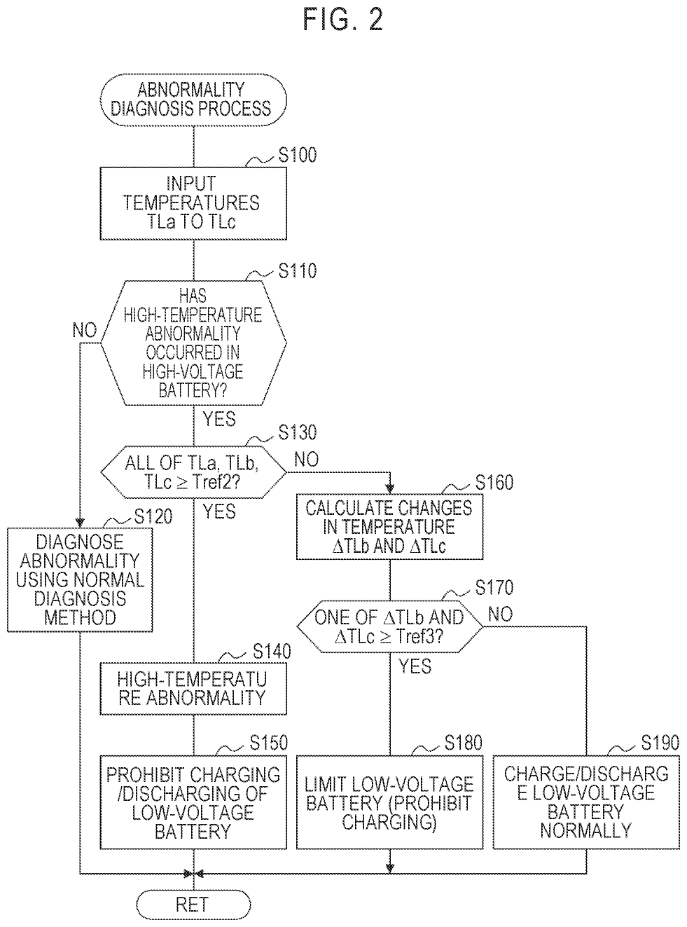

An operation of the power supply device that is mounted in the hybrid vehicle 20 according to the embodiment having the aforementioned configuration, that is, an operation of diagnosing a high-temperature abnormality in the low-voltage battery 67 when a high-temperature abnormality in the high-voltage battery 60 has been diagnosed, will be described below. A high-temperature abnormality in the high-voltage battery 60 is diagnosed, for example, when a temperature from one temperature sensor out of the plurality of temperature sensors 60a to 60c attached to the high-voltage battery 60 is equal to or higher than a first threshold value Tref1. The first threshold value Tref1 is predetermined as a temperature which is lower than a temperature at which an abnormality such as deformation occurs in cells of the high-voltage battery 60 and, for example, 65° C., 70° C., or 75° C. can be used. FIG. 2 is a flowchart illustrating an example of an abnormality diagnosis process which is performed by the HVECU 70 when a high-temperature abnormality of the low-voltage battery 67 is diagnosed. The abnormality diagnosis process is repeatedly performed at predetermined time intervals (for example, at intervals of several tens of msec).

When the abnormality diagnosis process is performed, the HVECU 70 first performs a process of inputting the temperatures TLa to TLc detected by the temperature sensors 67a to 67c attached to the low-voltage battery 67 (Step S100). Subsequently, the HVECU 70 determines whether a high-temperature abnormality has been diagnosed (a high-temperature abnormality has occurred) in the high-voltage battery 60 (Step S110). Diagnosis of a high-temperature abnormality in the high-voltage battery 60 is the same as described above. When it is determined that a high-temperature abnormality has not been diagnosed (a high-temperature abnormality has not occurred) in the high-voltage battery 60, the HVECU 70 diagnoses a high-temperature abnormality in the low-voltage battery 67 using a normal diagnosis method (Step S120) and ends this routine. Similarly to a method of diagnosing a high-temperature abnormality in the high-voltage battery 60, a method of diagnosing that a high-temperature abnormality has occurred in the low-voltage battery 67 when one of the temperatures TLa to TLc detected by the temperature sensors 67a to 67c is equal to or greater than a second threshold value Tref2 can be used as the normal diagnosis method. The second threshold value Tref2 is predetermined as a temperature which is lower than a temperature at which an abnormality such as deformation occurs in the low-voltage battery 67 and, for example, 65° C., 70° C., or 75° C. can be used. The second threshold value Tref2 may be the same temperature as the first threshold value Tref1 or may be different therefrom.

When it is determined in Step S110 that a high-temperature abnormality has been diagnosed (a high-temperature abnormality has occurred) in the high-voltage battery 60, the HVECU 70 determines whether all of the temperatures TLa to TLc detected by the temperature sensors 67a to 67c attached to the low-voltage battery 67 are equal to or greater than the second threshold value Tref2 (Step S130). When it is determined that all of the temperatures TLa to TLc are equal to or greater than the second threshold value Tref2, the HVECU 70 diagnoses that a high-temperature abnormality has occurred in the low-voltage battery 67 (Step S140), prohibits charging/discharging of the low-voltage battery 67 (Step S150), and ends this routine. The method of diagnosing a high-temperature abnormality in the low-voltage battery 67 in this case is different from the method of diagnosing a high-temperature abnormality in the low-voltage battery 67 in a normal state described above in Step S120 (the same method as the method of diagnosing a high-temperature abnormality in the high-voltage battery 60). Charging/discharging of the low-voltage battery 67 when a high-temperature abnormality has been diagnosed in the low-voltage battery 67 is prohibited to curb damage of the low-voltage battery 67 or the like.

When it is determined in Step S130 that one of the temperatures TLa to TLc is less than the second threshold value Tref2 (a high-temperature abnormality has not been diagnosed in the low-voltage battery 67), the HVECU 70 calculates changes in temperature ΔTLb and ΔTLc of the temperatures TLb and TLc detected by the temperature sensors 67b and 67c other than the temperature sensor 67a closest to the high-voltage battery 60 out of the plurality of temperature sensors 67a to 67c attached to the low-voltage battery 67 (Step S160). Specifically, the changes in temperature ΔTLb and ΔTLc are calculated by subtracting the temperatures TLb and TLc detected and input by the temperature sensors 67b and 67c when the abnormality diagnosis process was previously performed from the temperatures TLb and TLc detected by the temperature sensors 67b and 67c. In this case, the changes in temperature ΔTLb and ΔTLc are changes in temperature per start time interval of the abnormality diagnosis process. The changes in temperature ΔTLb and ΔTLc may be divided by the start time interval of the abnormality diagnosis process. In this case, changes in temperature per unit time are acquired.

Then, the HVECU 70 determines whether one of the changes in temperature ΔTLb and ΔTLc is equal to or greater than a third threshold value Tref3 (Step S170). As the third threshold value Tref3, a value which is less than a change in temperature per start time interval of the abnormality diagnosis process when a high-temperature abnormality has occurred in the low-voltage battery 67 can be employed, and it can be determined in advance by experiment or the like. When it is determined that one of the changes in temperature ΔTLb and ΔTLc is equal to or greater than the third threshold value Tref3, the HVECU 70 determines that a high-temperature abnormality has not occurred in the low-voltage battery 67 but there is a likelihood that a high-temperature abnormality will occur, limits charging/discharging of the low-voltage battery 67 such that discharging of the low-voltage battery 67 is not limited but charging thereof is prohibited (Step S180), and ends this routine. Accordingly, it is possible to curb an increase in temperature of the low-voltage battery 67 and to prevent a high-temperature abnormality in the low-voltage battery 67 from being detected at the same time at which a high-temperature abnormality in the high-voltage battery 60 is detected.

When it is determined in Step S170 that all of the changes in temperature ΔTLb and ΔTLc are less than the third threshold value Tref3, the HVECU 70 determines that there is no likelihood that a high-temperature abnormality will occur in the low-voltage battery 67, performs charging/discharging of the low-voltage battery 67 normally (Step S190), and ends this routine.

In the power supply device which is mounted in the hybrid vehicle 20 according to the aforementioned embodiment, when it is determined that a high-temperature abnormality has been diagnosed (a high-temperature abnormality has occurred) in the high-voltage battery 60, a high-temperature abnormality in the low-voltage battery 67 is diagnosed depending on whether all of the temperatures TLa to TLc detected by the temperature sensors 67a to 67c attached to the low-voltage battery 67 are equal to or greater than the second threshold value Tref2 (using a diagnosis method different from the method of diagnosing a high-temperature abnormality in the high-voltage battery 60). That is, in comparison with a case in which a high-temperature abnormality in the low-voltage battery 67 is diagnosed when the temperatures TLb and TLc detected by the temperature sensors 67b and 67c other than the temperature sensor 67a closest to the high-voltage battery 60 out of the temperature sensors 67a to 67c attached to the low-voltage battery 67 are less than the second threshold value Tref2 and the temperature TLa detected by the temperature sensor 67a is equal to or greater than the second threshold value Tref2, it is possible to more appropriately diagnose a high-temperature abnormality in the low-voltage battery 67 when a high-temperature abnormality in the high-voltage battery 60 has been diagnosed.

In the power supply device which is mounted in the hybrid vehicle 20 according to the embodiment, when a high-temperature abnormality has not been diagnosed (a high-temperature abnormality has not occurred) in the low-voltage battery 67 in a state in which a high-temperature abnormality has been diagnosed in the high-voltage battery 60 and one of the changes in temperature ΔTLb and ΔTLc per start time interval of the abnormality diagnosis process of the temperatures TLb and TLc detected by the temperature sensors 67b and 67c other than the temperature sensor 67a closest to the high-voltage battery 60 out of the temperature sensors 67a to 67c attached to the low-voltage battery 67 is equal to or greater than the third threshold value Tref3, charging/discharging of the low-voltage battery 67 is limited such that discharging of the low-voltage battery 67 is not limited but charging thereof is prohibited. Accordingly, it is possible to curb an increase in temperature of the low-voltage battery 67 and to prevent a high-temperature abnormality in the low-voltage battery 67 from being detected at the same time at which a high-temperature abnormality in the high-voltage battery 60 is detected.

In the power supply device which is mounted in the hybrid vehicle 20 according to the embodiment, when a high-temperature abnormality has not been diagnosed in the low-voltage battery 67 in a state in which a high-temperature abnormality has been diagnosed in the high-voltage battery 60 and one of the changes in temperature ΔTLb and ΔTLc of the temperatures TLb and TLc detected by the temperature sensors 67b and 67c other than the temperature sensor 67a closest to the high-voltage battery 60 out of the temperature sensors 67a to 67c attached to the low-voltage battery 67 is equal to or greater than the third threshold value Tref3, charging/discharging of the low-voltage battery 67 is limited such that discharging of the low-voltage battery 67 is not limited but charging thereof is prohibited. However, charging of the low-voltage battery 67 may not be prohibited but limited to a certain extent or discharging of the low-voltage battery 67 as well as charging thereof may be slightly limited.

In the power supply device which is mounted in the hybrid vehicle 20 according to the embodiment, the power supply device is mounted in a hybrid vehicle 20 in which the starter motor 25 is connected to the crank shaft 23 of the engine 22 and the motor 30 is also connected to the crank shaft 23 via the clutch 36. However, the power supply device may be mounted in a hybrid vehicle or an electric vehicle having various hardware configurations as long as the high-voltage battery 60 that supplies electric power to a driving motor and the low-voltage battery 67 that supplies electric power to auxiliary machinery or the like are provided. The power supply device may be mounted in a hybrid vehicle or an electric vehicle having various hardware configurations in which two high-voltage batteries that supply electric power to a driving motor are provided. The power supply device may be mounted in a vehicle or a mobile object other than an automobile as long as two batteries are provided, and may be assembled into a construction facility or the like.

Correspondence between principal elements of the embodiment and principal elements of the present disclosure described in the SUMMARY will be described below. In the embodiment, the high-voltage battery 60 corresponds to a “first battery,” the plurality of temperature sensors 60a to 60c corresponds to a “plurality of first temperature sensors,” the low-voltage battery 67 corresponds to a “second battery,” the plurality of temperature sensors 67a to 67c corresponds to a “plurality of second temperature sensors,” and the HVECU 70 corresponds to a “control unit.”

The correspondence between the principal elements in the embodiment and the principal elements of the present disclosure described in the does not limit the elements of the present disclosure described in the SUMMARY, because the embodiment is an example for specifically describing an aspect of the present disclosure described in the SUMMARY. That is, it should be noted that the present disclosure described in the SUMMARY has to be construed based on the description of the SUMMARY and the embodiment is only a specific example of the present disclosure described in the SUMMARY.

While an embodiment of the present disclosure has been described above, the applicable embodiment is not limited to the embodiment and can be modified in various forms without departing from the gist of the present disclosure.

The present disclosure is applicable to the manufacturing industry for power supply devices.

What is claimed is:

1. A power supply device comprising:
a first battery;
a plurality of first temperature sensors that is attached to the first battery;
a second battery that is provided adjacent to the first battery;
a plurality of second temperature sensors that is attached to the second battery; and
a control unit configured to manage the first battery and the second battery,
wherein the control unit is configured to diagnose a high-temperature abnormality of the second battery using a second abnormality diagnosis method based on temperatures from the plurality of second temperature sensors when a high-temperature abnormality has been detected in the first battery using a first abnormality diagnosis method different from the second abnormality diagnosis method based on temperatures from the plurality of first temperature sensors.

2. The power supply device according to claim 1, wherein the first abnormality diagnosis method is a method of diagnosing that the high-temperature abnormality has occurred in the first battery when the temperature from one of the plurality of first temperature sensors is equal to or greater than a first threshold value, and
wherein the second abnormality diagnosis method is a method of diagnosing that the high-temperature abnormality has occurred in the second battery when the temperature from all of the plurality of second temperature sensors is equal to or greater than a second threshold value.

3. The power supply device according to claim 1, wherein the control unit is configured to limit charging of the second battery when it is not diagnosed using the second abnormality diagnosis method that the high-temperature abnormality has occurred in the second battery in a state in which the high-temperature abnormality is detected in the first battery and when a change in temperature per predetermined time from one temperature sensor other than the temperature sensor provided closest to the first battery out of the plurality of second temperature sensors is equal to or greater than a predetermined change.
